(19) United States
(12) Patent Application Publication
(10) Pub. No.: US 2022/0248641 A1
(43) Pub. Date: Aug. 11, 2022

(54) INFORMATION PROVISION DEVICE, INFORMATION PROVISION METHOD, AND STORAGE MEDIUM

(71) Applicant: Toletta Cats Inc., Kanagawa (JP)

(72) Inventors: Koji Hori, Fujisawa-shi (JP); Teruki Hirahata, Fujisawa-shi (JP); Ayumi Matsubara, Fujisawa-shi (JP); Atsushi Hiroyama, Fujisawa-shi (JP)

(21) Appl. No.: 17/590,110

(22) Filed: Feb. 1, 2022

Related U.S. Application Data
(63) Continuation of application No. PCT/JP2020/014470, filed on Mar. 30, 2020.

(30) Foreign Application Priority Data
Aug. 1, 2019 (JP) 2019-142290

(51) Int. Cl. A01K 29/00; A01K 1/01; G01G 19/52; G06V 40/10; G06Q 30/06; G06N 20/00

(52) U.S. Cl. CPC A01K 29/005; A01K 1/0107; G06N 20/00; G06V 40/10; G06Q 30/0631; G01G 19/52

(57) ABSTRACT

An information provision device includes a processor configured to acquire a first variation amount of an amount of excrement and a second variation amount of a body weight in a pet, estimate a medical condition of the pet, based on the acquired first variation amount and the acquired second variation amount, and output provided information including the estimated medical condition.

### CROSS-REFERENCE TO RELATED APPLICATIONS

This application is a Continuation Application of PCT Application No. PCT/JP2020/014470, filed Mar. 30, 2020 and based upon and claiming the benefit of priority from prior Japanese Patent Application No. 2019-142290, filed Aug. 1, 2019, the entire contents of all of which are incorporated herein by reference.

### BACKGROUND OF THE INVENTION

### 1. Field of the Invention

The present invention relates generally to an information provision device, an information provision method, and a storage medium.

### 2. Description of the Related Art

In recent years, keeping pets such as cats in the home is widely known, and toilets dedicated to pets for appropriately treating the excrement of the pets have become widespread.

By the way, the health management of pets is a very important issue for owners of the pets, but it is difficult to recognize the medical condition of the pets at an early stage.

### SUMMARY OF THE INVENTION

According to one embodiment, an information provision device includes a processor configured to acquire a first variation amount of an amount of excrement and a second variation amount of a body weight in a pet, estimate a medical condition of the pet, based on the acquired first variation amount and the acquired second variation amount, and output provided information including the estimated medical condition.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a table showing IRIS staging of chronic kidney disease from which cats suffer.

FIG. 2 is a diagram showing an example of a configuration of an information provision system including the information provision device according to a first embodiment of the present invention.

FIG. 3 is a view showing an example of an appearance of a pet toilet in which a sensor device is incorporated.

FIG. 4 is a view schematically showing a cross section of a pet toilet as seen from the side where a pet enters the toilet.

FIG. 5 is a graph showing a weight transition measured by a weight sensor when a pet urinates in a pet toilet.

FIG. 6 is a graph showing a weight transition measured by the weight sensor when the pet exits the pet toilet without urinating.

FIG. 7 is a diagram showing an example of a hardware configuration of an information provision device.

FIG. 8 is a block diagram showing an example of a functional configuration of the information provision device.

FIG. 9 is a flowchart showing an example of a process procedure of the information provision device.

FIG. 10 is a table showing an example of a data structure of first management information.

FIG. 11 is a table showing an example of a data structure of second management information.

FIG. 12 is a table showing an example of a data structure of attribute information.

FIG. 13 is a graph showing an example of volatility distribution of target index.

FIG. 14 is a diagram showing an example of an increase and decrease pattern of each index in a pet.

FIG. 15 is a graph showing a weight transition measured by the weight sensor when a pet defecates in a pet toilet.

FIG. 16 is a block diagram showing an example of a functional configuration of an information provision device according to a second embodiment of the present invention.

FIG. 17 is a flowchart showing an example of a process procedure of the information provision device.

### DETAILED DESCRIPTION OF THE INVENTION

Various embodiments of the present invention will be described hereinafter with reference to the accompanying drawings.

### First Embodiment

First, the first embodiment of the present invention will be described. The (information provision system including the) information provision device according to the present embodiment is used by, for example, an owner (hereinafter referred to as a user) of a pet such as a cat.

For example, it is said that cats often suffer from illness of urinary system, and nearly half of them experience diseases of urinary tract disease. In addition, one of the diseases of urinary tract disease of cats that tends to become serious is chronic kidney disease (hereinafter referred to as CKD).

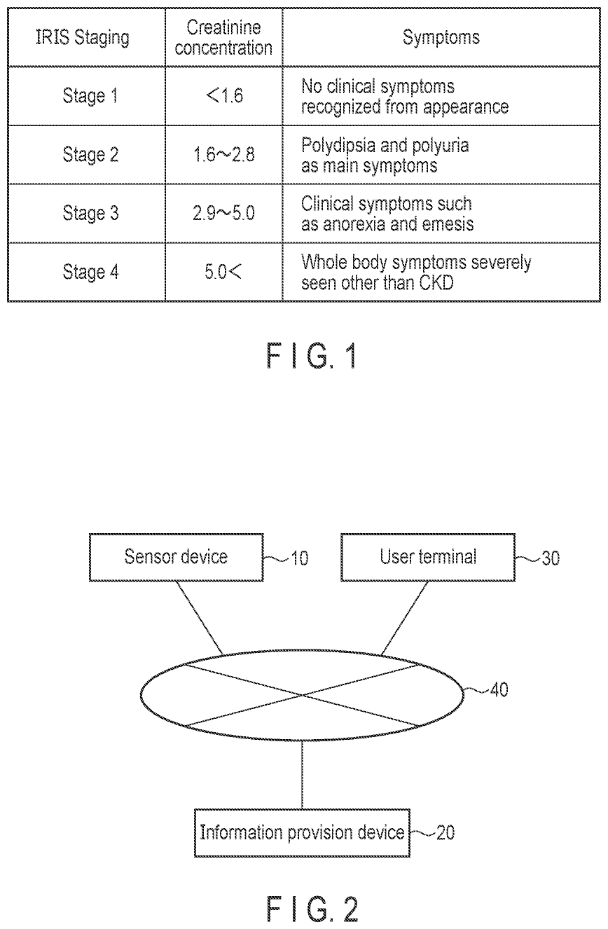

FIG. 1 shows IRIS staging of CKD from which cats suffer. According to the IRIS staging shown in FIG. 1, the severity of CKD is classified by blood creatinine concentration. The staging of CKD can be determined by performing a blood test.

It is desirable to detect CKD at an early stage to properly treat CKD. However, for cats case, it is difficult to detect CKD at an early stage since their opportunity to visit veterinary hospital is much less compared to dogs. At stage 4, since “systemic symptoms appear strongly”, it is easy for the owner to detect abnormalities but, treatment is often difficult even if the pet is examined at the hospital at this stage.

The “polydipsia and polyuria are seen” as the symptom of stage 2, and the owner can detect CKD at an early stage by checking whether the cat shows the symptom of polydipsia and polyuria.

In addition, some results of studies indicate that cats show signs of the reduction in body weight before the cats are diagnosed with chronic renal disease, and checking the body weight of the cat is also useful for early detection of CKD.

However, it is difficult for the owner to check on daily basis whether or not the cat shows any symptoms of polydipsia and polyuria, signs such as reduction in body weight.

Therefore, the information provision device according to the present embodiment includes a function of monitoring the amount of urine, the body weight, and the like of the pet such as the cat described above, and providing the user with information on the disease condition of the pet.

The information provision device according to the present embodiment will be described blow in detail. FIG. 2 shows an example of the configuration of an information provision system (network system) including the information provision device according to the present embodiment.

The information provision system shown in FIG. 2 mainly includes a sensor device 10, an information provision device 20, and a user terminal 30. The sensor device 10 and the user terminal 30 are communicably connected to the information provision device 20 via a network 40 such as the Internet. In addition, one sensor device 10 and one user terminal 30 are shown in FIG. 2 for convenience, but the information provision system may include a plurality of sensor devices 10 and user terminals 30.

The sensor device 10 is incorporated in a pet toilet used by the pet. The sensor device 10 includes various sensors and is used to measure the amount of urine and the body weight of the pet (for example, cat) described above.

The information provision device 20 is an electronic device (information processing device) that operates as a server device, and includes a function of estimating the disease condition of the pet, based on the amount of urine and the body weight of the pet measured by using the sensor device 10. The information provision device 20 may be, for example, a server device that provides a cloud computing service.

The user terminal 30 is an electronic device used by the user, i.e., the owner of the pet using the pet toilet in which the above-mentioned sensor device 10 is incorporated. The user terminal 30 implies, for example, a personal computer, a smartphone, a tablet computer, and the like.

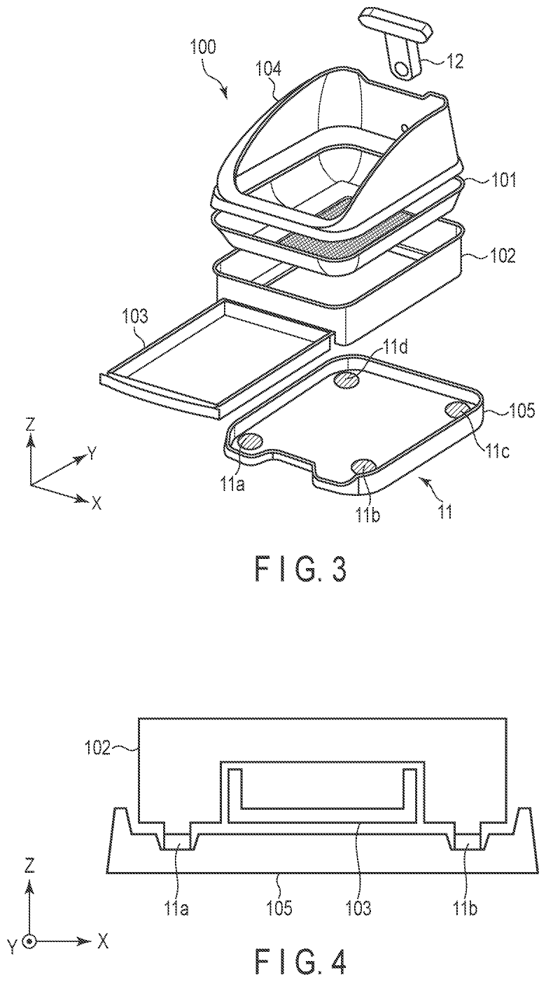

FIG. 3 shows an example of an appearance of the pet toilet in which the sensor device 10 shown in FIG. 1 is incorporated. FIG. 3 shows an example in which a pet toilet 100 is, for example, a multi-layer fully automatic toilet developed for cats.

As shown in FIG. 3, the pet toilet 100 includes an upper toilet container 101, a lower toilet container 102, and a urine collection tray 103.

The upper toilet container 101 forms a space for the pet to urinate, and for example, a drainboard is arranged on a bottom surface. It has been described that the drainboard is arranged on the bottom surface of the upper toilet container 101, but the bottom surface of the upper toilet container 101 may be formed such that the urine excreted by the pet can pass therethrough. When the pet using the pet toilet 100 is a cat, for example, cat sand is spread on the bottom surface (drainboard) of the upper toilet container 101.

The lower toilet container 102 is arranged below the upper toilet container 101 and is configured to support the upper toilet container 101.

The urine collection tray 103 is arranged at a position overlaid on the upper toilet container 101. In addition, a lower part of the lower toilet container 102 is notched such that the urine collection tray 103 can be pulled out from the notched part. For example, a pet sheet having a water absorbing and deodorizing effect, or the like can be laid on the urine collecting tray 103.

The pet toilet 100 shown in FIG. 3 is used in a state where the above-mentioned upper toilet container 101, lower toilet container 102, and urine collection tray 103 are stacked. When the pet urinates in such a pet toilet 100, the urine of the pet passes through the bottom surface (drainboard) of the upper toilet container 101 and is collected in the urine collection tray 103. According to this, the pet owner (user) can easily clean the pet urine by pulling out the urine collection tray 103 from the notch part of the lower toilet container 102.

A cover member 104 may be further attached to the upper toilet container 101 as shown in FIG. 3.

Furthermore, in the present embodiment, the pet toilet 100 includes a sensor plate 105 under the lower toilet container 102 and the urine collection tray 103. The sensor plate 105 is provided with a weight sensor (body weight sensor) 11.

In the example shown in FIG. 3, the sensor plate 105 has a substantially rectangular shape according to the shape of the lower toilet container 102, but the weight sensor 11 is configured by four sensors 11a to 11d arranged at four corners of the sensor plate 105. In the present embodiment, the weight sensor 11 is used to measure the amount of urine and the body weight of the pet as described above.

As shown in FIG. 3, for example, a camera 12 can be attached to the pet toilet 100. In the example shown in FIG. 3, the camera 12 is attached to the cover member 104, but may be attached to the other position as long as it is possible to image the state of the pet using the pet toilet 100.

The weight sensor 11 and the camera 12 described above configure the sensor device 10 incorporated in the pet toilet 100. Furthermore, it is assumed that the sensor device 10 includes, for example, a CPU, a memory, a wireless communication device and the like in addition to the weight sensor 11 and the camera 12, which is not illustrated in FIG. 3.

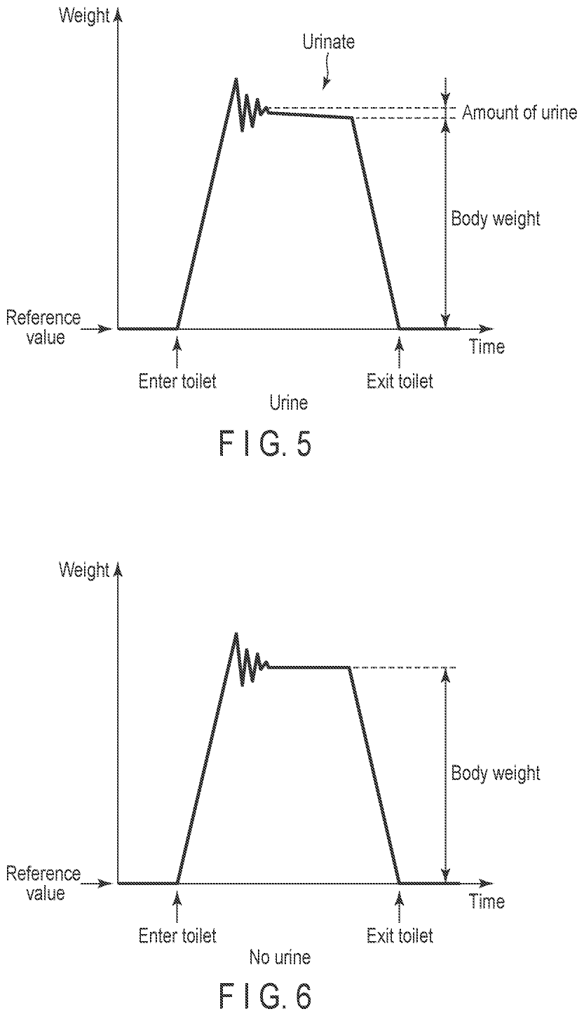

A principle of measuring the amount of urine and the body weight of the pet using the pet toilet 100 shown in FIG. 3 will be described below with reference to FIG. 4 and FIG. 5.

FIG. 4 schematically shows a cross section of the pet toilet 100 as seen from the side where the pet enters the toilet. In FIG. 4, the upper toilet container 101 and the cover member 104 mentioned above are omitted.

As shown in FIG. 4, the weight sensor 11 is configured to be able to measure the weight of the toilet body. It is assumed that the toilet body includes the upper toilet container 101, the lower toilet container 102, the cover member 104, and the like and does not include the urine collection tray 103. That is, in the present embodiment, the weight sensor 11 is configured not to measure the weight of the urine collection tray 103. It is assumed that the weight sensor 11 can constantly monitor (measure) the weight of the toilet body described above.

FIG. 5 shows the transition of the weight measured by the weight sensor 11 when the pet urinates in the pet toilet 100. A difference between the weight measured by the weight sensor 11 and a reference value is shown in FIG. 5. The reference value refers to the weight measured by the weight sensor 11 when the pet is not in the pet toilet 100 (that is, the weight of the toilet body). The value is also the same in drawings similar to FIG. 5 as mentioned below.

As shown in FIG. 5, when the pet enters the pet toilet 100, the weight measured by the weight sensor 11 increases according to the body weight of the pet.

When the pet entering the pet toilet 100 urinates, the urine of the pet is collected in the urine collection tray 103 as described above. In the present embodiment, since the weight sensor 11 does not measure the weight of the urine collection tray 103 (and the urine collected in the urine collection tray 103), the weight measured by the weight sensor 11 decreases according to the amount of urine excreted from the body of the pet (that is, the amount of excreted urine). That is, in the present embodiment, the amount of urine of the pet can be obtained by monitoring the decrease of the weight measured by the weight sensor 11.

In addition, the above-described weight of the pet measured by the weight sensor 11 after urination (difference from the reference value) can be obtained as the body weight of the pet.

Even when the pet enters the pet toilet 100, the pet may exit the toilet without urinating. FIG. 6 shows the transition of the weight measured by the weight sensor 11 in such a case. In this case, the weight (difference from the reference value) measured by the weight sensor 11 after the pet enters the pet toilet 100 can be obtained as the body weight of the pet. That is, when no change is found in the weight measured by the weight sensor 11 in the period from entering the pet toilet 100 to exiting the toilet, it can be determined that the pet has exited the toilet without urinating.

In the present embodiment, as described above, the weight sensor 11 is used to measure the amount of urine and the body weight of the pet, but the sensor device 10 may include the other sensor and measure the amount of urine and the body weight of the pet by using the other sensor.

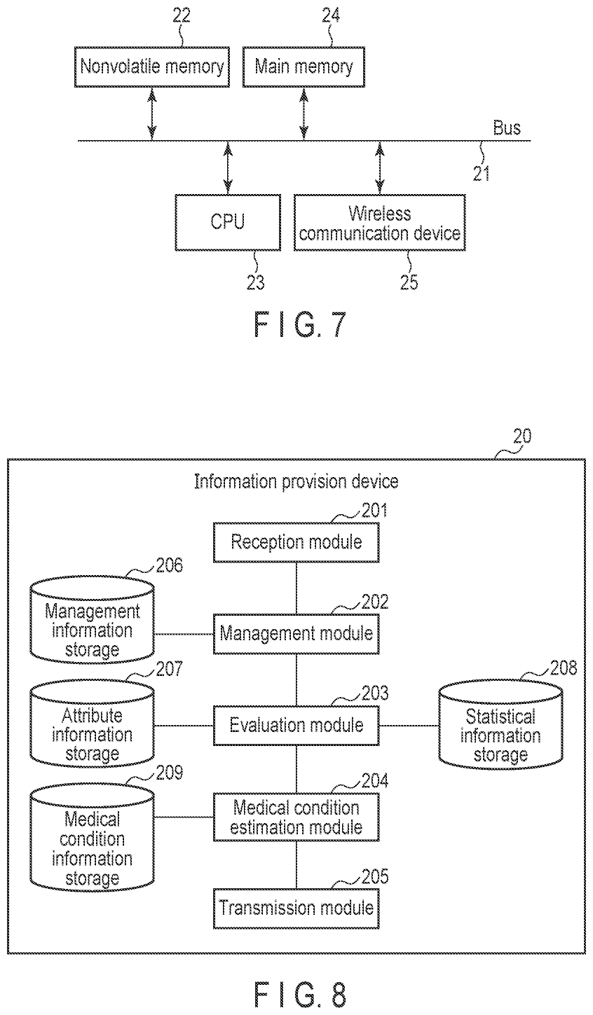

Next, FIG. 7 shows an example of the hardware configuration of the information provision device 20. As shown in FIG. 7, the sensor device 10 includes a nonvolatile memory 22, a CPU 23, a main memory 24, a wireless communication device 25, and the like, which are connected to a bus 21.

The nonvolatile memory 22 stores various programs. The various programs stored in the nonvolatile memory 22 include, for example, a program for realizing a function of providing the user with an operating system (OS) and the above-mentioned information on the pet's medical condition (hereinafter referred to as an information provision program).

The CPU 23 executes the various programs stored in, for example, the nonvolatile memory 22. The CPU 23 controls the entire information provision device 20.

The main memory 24 is used as, for example, a work area required when the CPU 23 executes the various programs.

The wireless communication device 25 includes a function of controlling wireless communication with the sensor device 10 and the user terminal 30 described above.

Only the nonvolatile memory 22 and the main memory 24 are shown in FIG. 7, but the information provision device 20 may include other storage devices such as a hard disk drive (HDD) and a solid state drive (SSD).

FIG. 8 is a block diagram showing an example of the functional configuration of the information provision device 20. As shown in FIG. 8, the device includes a reception module 201, a management module 202, an evaluation module 203, a medical condition estimation module 204, a transmission module (output module) 205, management information storage 206, attribute information storage 207, statistical information storage 208, and medical condition information storage 209.

It is assumed that in the present embodiment, the reception module 201, the management module 202, the evaluation module 203, the medical condition estimation module 204, and the transmission module 205 are implemented by, for example, the CPU 23 (that is, the computer of the information provision device 20) shown in FIG. 7 executing the information provision program stored in the nonvolatile memory 22, i.e., by software. This information provision program can be stored in advance in a computer-readable storage medium and distributed. In addition, this information provision program may be, for example, downloaded to the information provision device 20 via the network 40.

It has been described that each of the modules 201 to 205 is implemented by software, but each of the modules 201 to 205 may be realized by, for example, hardware or may be realized as a combined configuration of software and hardware.

In addition, in the present embodiment, the management information storage 206, the attribute information storage 207, the statistical information storage 208, and the medical condition information storage 209 are realized by, for example, the nonvolatile memory 22 shown in FIG. 7, the other storage device, or the like.

The above-described sensor device 10 (pet toilet 100) continuously transmits to the information provision device 20 the weight (hereinafter referred to as sensor information) measured by the weight sensor 11 provided in the sensor device 10 while the pet uses the pet toilet 100. Similarly, the sensor device 10 transmits an image (for example, a moving image) captured by the camera 12 provided in the sensor device 10 to the information provision device 20 while the pet uses the pet toilet 100.

The reception module 201 receives the sensor information and the image transmitted from the sensor device 10 as described above.

The management module 202 acquires the amount of urine (amount of excreted urine) excreted by the pet in the pet toilet 100 and the body weight, based on the sensor information received by the reception module 201, and generates the information (hereinafter referred to as first management information) including the amount of excreted urine and the body weight. This first management information is information on one use of the pet toilet 100. The first management information also includes an image received by the reception module 201.

The management information storage 206 stores the first management information generated by the management module 202. The first management information is stored in the management information storage 206 every time the pet uses the pet toilet 100.

In addition, the management module 202 generates information (hereinafter referred to as second management information) on the use of the pet toilet 100 for a predetermined period (for example, one day), based on the first management information stored (accumulated) in the management information storage 206. The second management information includes the amount of excreted urine and the body weight, similarly to the first management information.

The management module 202 calculates the volatility (change amount) of the amount of excreted urine and the body weight in the pet, based on the generated second management information.

The attribute information storage 207 stores in advance information (hereinafter referred to as attribute information) on the pet using the pet toilet 100.

The statistical information storage 208 stores in advance statistical information on the volatilities (variation amounts) of the amounts of excreted urine and the body weights in a plurality of pets other than the above-described pet using the pet toilet 100.

The evaluation module 203 evaluates the fluctuation rate calculated by the management module 202, based on the attribute information stored in the attribute information storage 207 and the statistical information stored in the statistical information storage 208, and acquires the increase and decrease patterns of the amount of excreted urine and the body weight in the pet.

The medical condition information storage 209 stores in advance information (hereinafter referred to as medical condition information) used to estimate the medical condition of the pet. More specifically, the medical condition information is information indicating a medical condition from which the pet corresponding to the increase and decrease patterns may suffer, for each of the increase and decrease patterns of the amount of excreted urine and the body weight.

The medical condition estimation module 204 estimates the medical condition of the pet, based on the increase and decrease patterns (variation amounts) of the amount of excreted urine and the body weight in the pet acquired by the evaluation module 203 and the medical condition information stored in the medical condition information storage 209.

The transmission module 205 transmits (outputs) the provided information including the result estimated by the medical condition estimation module 204 (that is, the medical condition of the pet) to, for example, the user terminal 30. The provided information transmitted by the transmission module 205 may include an image or the like included in the above-described first management information.

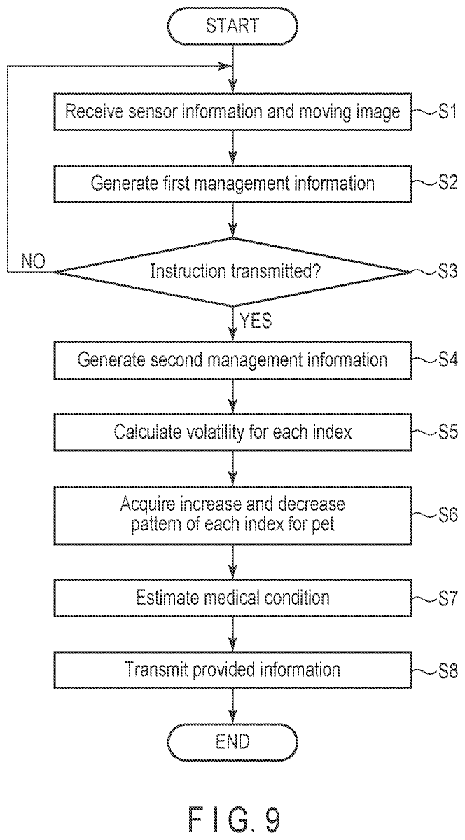

An example of the processing procedure of the information provision device 20 according to the present embodiment will be described below with reference to the flowchart of FIG. 9.

First, when the pet uses the pet toilet 100 in which the sensor device 10 is incorporated, the weight measured by the weight sensor 11 provided in the sensor device 10 is varied in accordance with the body weight of the pet, by the pet entering the pet toilet 100. According to this, the sensor device 10 can detect a condition that the pet has entered the pet toilet 100 (that is, started using the pet toilet 100), based on the weight measured by the weight sensor 11.

Similarly, when the pet exits the pet toilet 100, the weight measured by the weight sensor 11 is varied in accordance with the body weight of the pet. For this reason, the sensor device 10 can detect a condition that the pet has exited the pet toilet 100 (that is, ended using the pet toilet 100), based on the weight measured by the weight sensor 11.

In this case, the sensor device 10 continuously transmits to the information provision device 20 the weight (sensor information) measured by the weight sensor 11 in a period after the pet enters the pet toilet 100 and before the pet exits the pet toilet 100. It is assumed that the date and time when it is detected that the pet has entered the pet toilet 100 (hereinafter referred to as the date and time of entry), and the date and time when it is detected that the pet has exited the pet toilet 100 (hereinafter referred to as the date and time of exit) are added to the sensor information transmitted from the sensor device 10 to the information provision device 20.

In addition, for example, the sensor device 10 turns on the power of the camera 12 when the pet enters the pet toilet 100, and turns off the power of the camera 12 when the pet exits the pet toilet 100. According to this, the camera 12 can capture a moving image including the state of the pet while using the pet toilet 100. In this case, the sensor device 10 transmits the moving image captured by the camera 12 to the information provision device 20. It has been described that the camera 12 captures a moving image, but the camera 12 may capture a still image.

In addition to the above-mentioned sensor information and moving image, for example, the sensor device 10 transmits to the information provision device 20 identification information (hereinafter referred to as user ID and pet ID) for identifying the user and the pet registered in advance in the pet toilet 100 in which the sensor device 10 is incorporated.

The reception module 201 receives the sensor information, the moving image, the user ID, and the pet ID transmitted from the sensor device 10 as described above (step S1).

Next, the management module 202 generates the first management information on one use of the pet toilet 100, based on the sensor information received in step S1 (step S2).

In this case, the management module 202 acquires the date and time of entry and the date and time of exit added to the sensor information received in step S1. In addition, the management module 202 acquires the amount of excreted urine and the body weight of the pet in the pet toilet 100, based on the sensor information received in step S1.

The sensor information is information indicating the transition of the weight measured by the weight sensor 11 as shown in FIG. 5 described above. That is, according to such sensor information, it is possible to acquire (measure) the amount of excreted urine and the body weight of the pet as described with reference to FIG. 4 and FIG. 5 described above. In addition, when the pet exits the pet toilet 100 without urinating, the management module 202 acquires only the body weight of the pet as described with reference to FIG. 6.

Thus, the management module 202 generates the first management information including the date and time of entry, the date and time of exit, the amount of excreted urine, and the body weight described above, and the moving image received in step S1, in association with the user ID and pet ID received in step S1.

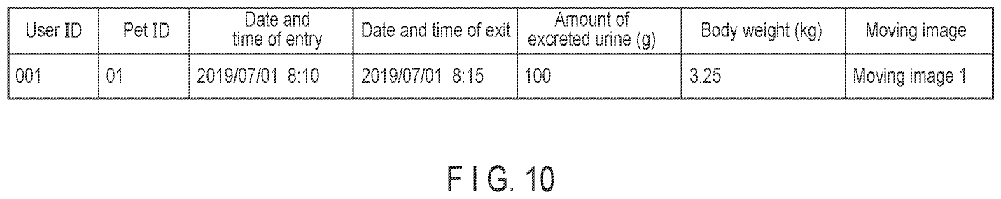

FIG. 10 shows an example of the data structure of the first management information generated by the management module 202 in step S2.

In the example shown in FIG. 10, the first management information includes the date and time of entry “2019/07/01 8:10”, the date and time of exit “2019/07/01 8:15”, the amount of excreted urine “100 (g)”, the body weight “3.25 (kg)”, and the moving image “moving image 1”, in association with the user ID “001” and the pet ID “01”.

According to this first management information, it is indicated that the pet (i.e. the pet identified by the pet ID “01” kept by the user identified by the user ID “001”) entered the pet toilet 100 at 8:10 on Jul. 1, 2019 and exited the pet toilet 100 at 8:15 on Jul. 1, 2019. In addition, according to the first management information shown in FIG. 10, it is indicated that the amount of excreted urine of the pet in the use of the pet toilet 100 is 100 g and the body weight of the pet is 3.25 kg. Furthermore, according to the first management information shown in FIG. 10, it is indicated that the moving image (file) captured while the pet uses the pet toilet 100 is the “moving image 1”.

Generating one element of first management information has been described, but steps S1 and S2 shown in FIG. 9 described above are executed every time the pet uses the pet toilet 100.

The first management information generated in step S2 is stored (accumulated) in the management information storage 206.

By the way, in the present embodiment, for example, the user instructs the information provision device 20 to transmit the above-described provided information (i.e., to estimate the medical condition of the pet) by activating a predetermined application program on the user terminal 30 and operating the user terminal 30.

The information provision device 20 determines whether or not such an instruction is transmitted from the user (step S3).

When it is determined that no instruction is transmitted from the user (NO in step S3), the flow returns to step S1 and the processes are repeated.

In contrast, when it is determined that an instruction is transmitted from the user (YES in step S3), the management module 202 generates the second management information on one-day use of the pet toilet 100, based on the first management information stored in the management information storage 206 (step S4).

The second management information generated in step S4 includes the second management information of the current day and the second management information of the previous day. The second management information of the current day is, for example, the second management information on the use of the pet toilet 100 within past 24 hours from a first calculation date and time where the date and time when the above user instructs to transmit the provided information is the calculation date and time (hereinafter referred to as the first calculation date and time). In contrast, the second management information on the previous day is the second management information on the use of the pet toilet 100 within past 24 hours from a second calculation date and time where the date and time 24 hours before the date and time when the user instructs to transmit the provided information (i.e., the first calculation date and time) is the calculation date and time (hereinafter referred to as the second calculation date and time).

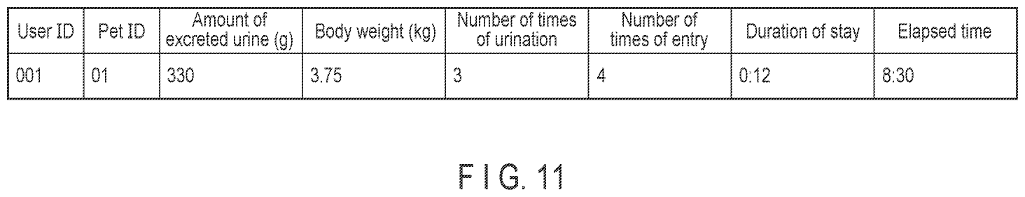

FIG. 11 shows an example of the data structure of the second management information (second management information on the current day and the previous day) generated in step S4. As shown in FIG. 11, the second management information includes the amount of excreted urine, the body weight, the number of times of urination, the number of times of entry, the duration of stay, and the elapsed time in association with the user ID and the pet ID.

The amount of excreted urine is the total amount of excreted urine of the pet in a day. For example, in the case of the second management information of the current day, the amount of excreted urine included in the second management information of the current day can be calculated by summing up the amount of excreted urine included in the first management information in which the date and time of entry (and the date and time of exit) correspond to those within past 24 hours from the first calculation date and time. In contrast, for example, in the case of the second management information of the previous day, the amount of excreted urine included in the second management information of the previous day can be calculated by summing up the amount of excreted urine included in the first management information in which the date and time of entry (and the date and time of exit) correspond to those within past 24 hours from the second calculation date and time.

The body weight is the latest body weight of the pet in a day. For example, in the case of the second management information of the current day, the body weight included in the second management information of the current day is the body weight included in the first management information in which the date and time of entry (and the date and time of exit) are closest to the first calculation date and time, of the first management information in which the date and time of entry (and the date and time of exit) correspond to those within past 24 hours from the first calculation date and time. In contrast, for example, in the case of the second management information of the previous day, the body weight included in the second management information of the previous day is the body weight included in the first management information in which the date and time of entry (and the date and time of exit) are closest to the second calculation date and time, of the first management information in which the date and time of entry (and the date and time of exit) correspond to those within past 24 hours from the second calculation date and time. The body weight included in the second management information (i.e., the second management information of the current day and the second management information of the previous day) may be, for example, an average value of the body weight included in the first management information in which the date and time of entry (and the date and time of exit) correspond to those within 24 hours from the calculation date and time.

The number of times of urination is the number of times of urination of the pet in a day. For example, in the case of the second management information of the current day, the number of times of urination included in the second management information of the current day corresponds to the number of elements of the first management information including the amount of excreted urine more than or equal to a predetermined value, of the first management information in which the date and time of entry (and the date and time of exit) correspond to those within past 24 hours from the first calculation date and time. In contrast, for example, in the case of the second management information of the previous day, the number of times of urination included in the second management information of the previous day corresponds to the number of elements of the first management information including the amount of excreted urine more than or equal to a predetermined value, of the first management information in which the date and time of entry (and the date and time of exit) correspond to those within past 24 hours from the second calculation date and time. In the present embodiment, the urination of the pet is counted (aggregated) when the above-mentioned predetermined value is set to, for example, 5 g and when the weight detected as the amount of excreted urine exceeds 5 g.

The number of times of entry is the number of times at which the pet enters the pet toilet 100 in a day. For example, in the case of the second management information of the current day, the number of times of entry included in the second management information of the current day corresponds to the number of elements of the first management information in which the date and time of entry (and the date and time of exit) correspond to those within past 24 hours from the first calculation date and time. In contrast, for example, in the case of the second management information of the previous day, the number of times of entry included in the second management information of the previous day corresponds to the number of elements of the first management information in which the date and time of entry (and the date and time of exit) correspond to those within past 24 hours from the second calculation date and time. The number of times of entry is different from the above-mentioned number of times of urination in being counted even when the pet enters the pet toilet 100 but exists without urinating (that is, all the first management information is summed up as one count regardless of excretion or no excretion).

The duration of stay is the total value of the time at which the pet stays in the pet toilet 100 in a day. For example, in the case of the second management information of the current day, the duration of stay included in the second management information of the current day can be calculated by summing up the time from the date and time of entry to the date and time of exit, which is included in the first management information in which the date and time of entry (and the date and time of exit) correspond to those within past 24 hours from the first calculation date and time. In contrast, for example, in the case of the second management information of the previous day, the duration of stay included in the second management information of the previous day can be calculated by summing up the time from the date and time of entry to the date and time of exit, which is included in the first management information in which the date and time of entry (and the date and time of exit) correspond to those within past 24 hours from the second calculation date and time. It has been described that the duration of stay included in the second management information is the total value of the duration of stay of the pet in the pet toilet 100 in a day but, instead of the total value of the duration of stay, an average value of the duration of stay may be included in the second management information.

The elapsed time is the maximum value (longest value) of the interval of the pet's use of the pet toilet 100 in a day. For example, in the case of the second management information of the current day, the first management information in which the date and time of entry (and the date and time of exit) correspond to those within past 24 hours from the first calculation date and time is arranged in the order of the date and time of entry, a difference (i.e., a usage interval) between the date and time of exit included in the first management information with earlier date and time of entry and the date and time of entry included in the first management information with the later date and time of entry, of the first management information arranged in the order of the date and time of entry, is calculated for each element of the first management information arranged adjacent, and a maximum value of the calculated differences is referred to as the elapsed time included in the second management information of the current day. In contrast, for example, in the case of the second management information of the previous day, the first management information in which the date and time of entry (and the date and time of exit) correspond to those within past 24 hours from the first calculation date and time is arranged in the order of the date and time of entry, the difference between the date and time of exit included in the first management information with earlier date and time of entry and the date and time of entry included in the first management information with the later date and time of entry, of the first management information arranged in the order of the date and time of entry, is calculated for each element of the first management information arranged adjacent, and a maximum value of the calculated differences is referred to as the elapsed time included in the second management information of the previous day. The usage interval corresponds to the time between the time of exit for the earlier date and time of entry and the time of entry for the later date and time of entry, of the adjacent data selected after arranging the first or second management information in order of dates and times of entry. It has been described that the elapsed time included in the second management information is the maximum value of the usage interval of the pet toilet 100 in a day, but, instead of the maximum value of the usage intervals, an average value of the usage intervals may be used as the elapsed time.

Only one second management information (i.e., the second management information of the current day or the second management information of the previous day) is shown in FIG. 11, and the second management information includes the amount of excreted urine “330”, the body weight “3.75”, the number of times of urination “3”, the number of times of entry “4”, the duration of stay “0:12”, and the elapsed time “8:30” in association with the user ID “001” and the pet ID “01”.

According to this second management information, it is indicated that the daily amount of excreted urine of the pet (i.e., the pet identified by the pet ID “01” kept by the user identified by the user ID “001”) is 330 g, the latest body weight of this pet in a day is 3.75 kg, and the number of times of urination of this pet in a day is three times. Furthermore, according to the second management information, it is indicated that the number of times at which the pet enter the pet toilet 100 in a day is four times, the time (total value) for which the pet stays in the pet toilet 100 in a day is 12 minutes, and the maximum value of the use interval in a day for the pet is 8 hours and 30 minutes.

When the above-described process of step S4 shown in FIG. 9 is executed, the second management information of the current day and the second management information of the previous day having the data structure described with reference to FIG. 11 are generated. It has been described that the first calculation date and time at which the second management information of the current day is generated assumed to be the date and time at which transmission of the provided information is instructed by the user, but the first calculation date and time may be, for example, a predetermined time (for example, 0 o'clock AM or the like) on the day when transmission of the provided information is instructed by the user, or the other date and time. Furthermore, it has been described that the second management information is generated in units of one day (24 hours), but the second management information may be generated in a shorter unit (for example, 12 hours or the like) or a longer unit (for example, 2 days, or the like).

In the following descriptions, each of the amount of excreted urine, the body weight, the number of times of urination, the number of times of entry, the duration of stay and the elapsed time included in the second management information (second management information on the current day and second management information on the previous day) is referred to as an index for convenience.

When the process of step S4 is executed, the evaluation module 203 calculates the volatility of each index (i.e., the amount of excreted urine, the body weight, the number of times of urination, the number of times of entry, the duration of stay and the elapsed time) included in the second management information, based on the second management information of the current day and the second management information of the previous day generated in step S4 (step S5). The volatility of each index calculated in step S5 indicates the amount of variation from the previous day to the current day of each index and corresponds to, for example, a ratio of the value of the index included in the second management information of the current day to the value of the index included in the second management information of the previous day (i.e., “the value of the index included in the second management information of the current day/the value of the index included in the second management information of the previous day”).

It is assumed below that the volatilities of all the indexes included in the second management information are calculated in step S5, but the volatilities of all the indexes may not be calculated in step S5. For example, when the pet is a cat as described above and the purpose is mainly early detection of CKD, at least the amount of excreted urine and the volatility of the body weight may be calculated in step S5.

Next, the evaluation module 203 evaluates the volatility of each index calculated in step S5, based on the attribute information stored in the attribute information storage 207 and the statistical information stored in the statistical information storage 208, and acquires the increase and decrease pattern of each index in the pet (step S6).

The process of step S6 will be described below in detail, and the attribute information and statistical information used in the process of step S6 will be first described in brief.

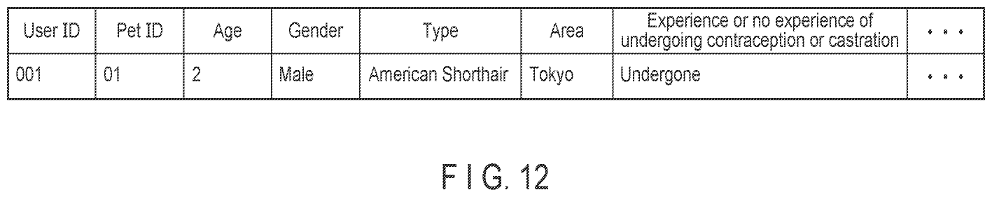

FIG. 12 shows an example of the data structure of the attribute information stored in the attribute information storage 207. As shown in FIG. 12, the attribute information includes age, gender, type, region (residence), experience or no experience of undergoing contraception and castration, and the like in association with the user ID and the pet ID. It is assumed that the pet is a cat for the attribute information shown in FIG. 12.

In the example shown in FIG. 12, the attribute information includes an age “2”, a gender “male”, a type “American Shorthair”, and an area “Tokyo” in association with the user “001” and the pet ID “01”. According to this attribute information, it is indicated that the age of the pet (i.e., the pet identified by the pet ID “01” kept by the user identified by the user ID “001”) is 2 years old, the gender of the pet is male, the pet type (cat breed) is American Shorthair, the residential area of the pet (user) is Tokyo, and the pet has undergone contraception or castration.

In the example shown in FIG. 12, it has been described that the attribute information includes the age, gender, type, region, and experience or no experience of undergoing contraception and castration, but the attribute information may include, for example, other items (information) such as the type of food, a vaccination history, hospitals, history of attending hospitals, number of pets (for example, cats) living together, condition of being insured or uninsured, and age and gender of the owner (user). For example, the content of each item included in the attribute information is registered by the user via the user terminal 30 or the like, but may be automatically registered in cooperation with the other system or the like different from the information provision system.

Next, the statistical information will be described, and the statistical information may be any information that statistically indicates the volatility of each index described above (i.e., the volatility of each index in a plurality of other pets).

When a number of users use the information provision system of the present embodiment and a large number of pets use the pet toilets 100 owned by the respective users, the volatility of each index in each of the pets can be obtained. For this reason, in the present embodiment, the volatility of each index in each of the plurality of other pets thus obtained may be used as the statistical information. Furthermore, the first management information stored in the management information storage 206 may be used as the statistical information. In addition, for example, the statistical information may be prepared (created) outside the information provision device 20 (information provision system).

Next, the process of step S6 shown in FIG. 9 will be described. In step S6, the evaluation module 203 classifies (categorizes) pets into one or more categories based on, for example, the above-mentioned attribute information. Such classification of the pets is executed based on contents of an item (i.e., each item included in the attribute information) having a high probability of affecting each of the above indexes (i.e., the contribution rate for explaining each of the indexes) by using, for example, principal component analysis or the like. According to this, for example, pets are classified into the same category as a plurality of other pets that are common in at least one of, for example, age, gender, type, region, and the like. For example, “common in age” implies that the age of pets falls within the same predetermined range (1 to 5 years old, 6 to 10 years old, or the like). That is, it is assumed that the term “common” in classifying the pets implies not only the same (i.e., matching) cases, but also similar (or like) cases. In this classification of pets, for example, public data (for example, temperature, humidity, weather, and the like) acquired from an external system of an information provision system via the Internet may be further used.

Next, the evaluation module 203 acquires the volatility (statistical information) of each index in other pets belonging to the category in which the pet is classified. According to the statistical information, the evaluation module 203 can obtain statistical distribution of the volatility of each index (hereinafter referred to as the volatility distribution).

In the present embodiment, the evaluation module 203 evaluates the volatility of each index calculated in step S5 in, for example, five stages using the volatility distribution obtained from such statistical information. It is assumed that the evaluation results in this case include “increase” indicating that the degree of increase in the index value is large, “slight increase” indicating that the degree of increase in the index value is small, “no increase or decrease” indicating that the index value does not increase or decrease, “slight decrease” indicating that the degree of decrease in the index value is small, and “decrease” indicating that the degree of decrease in the index value is large.

Evaluating the volatility of one (hereinafter referred to as a target index) of the indexes will be described below.

First, when the volatility of the target index is located in upper 5% of the total number of pets in the volatility distribution of the target index, the evaluation of the volatility of the target index is defined as “increase”.

In addition, when the volatility of the target index is located in upper 6% to 10% of the total number of pets in the volatility distribution of the target index, the evaluation of the volatility of the target index is defined as “slight increase”.

Furthermore, when the volatility of the target index is located in lower 6% to 10% of the total number of pets in the volatility distribution of the target index, the evaluation of the volatility of the target index is defined as “slight decrease”.

Furthermore, when the volatility of the target index is located in lower 5% of the total number of pets in the volatility distribution of the target index, the evaluation of the volatility of the target index is defined as “decrease”.

Incidentally, when the evaluation of the volatility of the target index does not correspond to any of “increase”, “slight increase”, “slight decrease”, and “decrease”, the evaluation is defined as “no increase or decrease”.

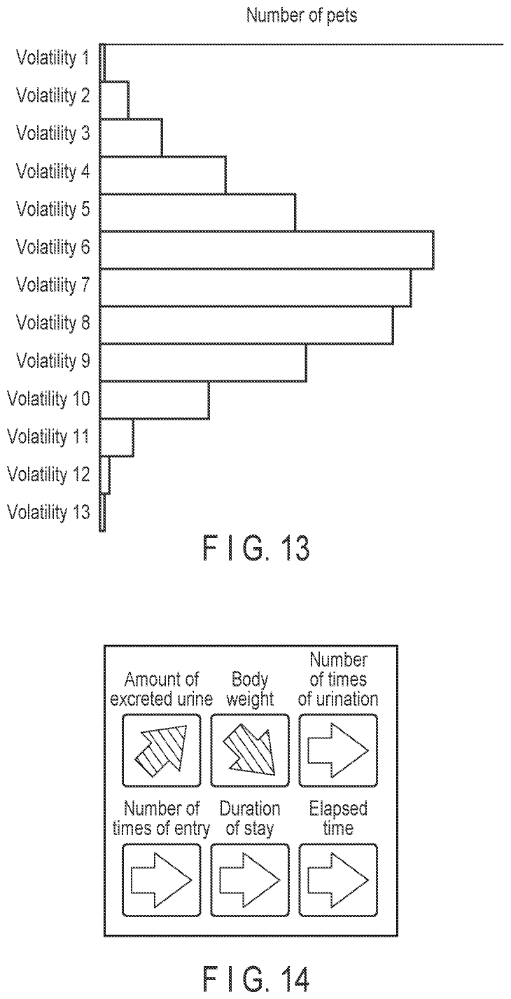

FIG. 13 shows an example of the volatility distribution of the target index. In FIG. 13, the horizontal axis represents the volatility of the target index, and it is assumed that the volatility increases in order of “volatility 1” to “volatility 13”. It is assumed that each of “volatility 1” to “volatility 13” has a certain range (for example, A % to B % and the like). In contrast, the vertical axis represents the number of pets corresponding to each of the volatilities of the target index (“volatility 1” to “volatility 13”) (i.e., the number of pets whose value of the target index fluctuates at the volatility).

In the example shown in FIG. 13, when the volatility of the target index corresponds to, for example, “volatility 4” and is located in lower 6% to 10% of the total number of pets in the volatility distribution of the target index, the evaluation of the volatility of the target index is “slight decrease”.

In contrast, when the volatility of the target index corresponds to, for example, “volatility 12” and is located in upper 5% of the total number of pets in the volatility distribution of the target index, the evaluation of the volatility of the target index is defined as “increase”.

When the volatility of the target index corresponds to, for example, “volatility 8”, the evaluation of the volatility of the target index is defined as “no increase or decrease” since the evaluation does not correspond to any of “increase (upper 5%)”, “slight increase (upper 6% to 10%)”, “slight decrease (lower 6% to 10%)”, and “decrease (lower 5%)”.

One of the above-mentioned plurality of indexes has been described here, and such an evaluation process is executed for all the indexes for which the volatilities are calculated.

Each numerical value (for example, upper 5% or the like) described for the above-described evaluation of the volatility of each index is an example and can be modified as appropriate. In addition, the evaluation of the volatility of each index does not need to be performed in five stages, and may be performed in, for example, three stages of “increase”, “decrease”, and “no increase or decrease”, or may be performed in six or more stages.

In addition, the evaluation of the volatility of each index may be performed in consideration of, for example, an average value, a median value, a mode value, or the like in the volatility distribution of each index.

Next, the evaluation module 203 acquires the increase and decrease pattern of each index in the pet, based on the evaluation result for the above-described volatility of each index. In the present embodiment, the “increase and decrease pattern of each index in the pet” corresponds to combination of the evaluation results (“increase”, “slight increase”, “no increase or decrease”, “slightly decrease”, and “decrease”) for the volatility of each index.

For example, it is assumed that the indexes are the amount of excreted urine, the body weight, the number of times of urination, the number of times of entry, the duration of stay, and the elapsed time, that the evaluation for the volatility of the amount of excreted urine is “slight increase”, that the evaluation for the volatility of the body weight is “slight decrease”, and that the evaluations for the volatilities of the number of times of urination, the number of times of entry, the duration of stay, and the elapsed time are “no increase or decrease”. In this case, the evaluation module 203 acquires an increase and decrease pattern as shown in FIG. 14 as the increase and decrease pattern of each index in the pet.

In the process of step S6, it has been described that the increase and decrease pattern is acquired by using the volatility of each index (“value of the index included in the second management information of the current day/value of the index included in the second management information of the previous day”), but the increase and decrease pattern may be acquired by using the difference (that is, the amount of variation) between each index of the previous day and that of the current day instead of the volatility.

When the process of step S6 is executed, the medical condition estimation module 204 estimates the medical condition of the pet, based on the increase and decrease pattern of each index acquired in step S6 and the medical condition information stored in the medical condition information storage 209 (step S7).

In the present embodiment, “estimating the medical condition of the pet” means matching the increase and decrease pattern of each index with the medical condition from which the pet may suffer. More specifically, in the medical condition information, for example, the medical condition from which the pet having the fluctuating value of each index as indicated by the increase and decrease patterns may suffer is associated with various increase and decrease patterns that the evaluation module 203 can acquire in step S6. The medical condition estimation module 204 can estimate the medical condition of the pet from the increase and decrease pattern of each index in the pet acquired in step S6, by using such medical condition information. More specifically, in a case where the increase and decrease patterns of polyuria and weight reduction are associated with the medical condition of CKD in the medical condition information, when the above-described increase and decrease patterns shown in FIG. 14 are acquired in step S6, CKD can be estimated as the medical condition of the pet.

In addition, in step S7, the medical condition of the pet may be estimated using, for example, a technique called machine learning or artificial intelligence. More specifically, a learned model (statistical model) generated by learning a data set of the increase and decrease pattern of each index in each of a plurality of other pets and the actual medical condition (i.e., the diagnosis result in the hospital) of the pet, is prepared in advance. The learned model may be generated in the information provision device 20 or may be generated in the other server device or the like outside the information provision device 20. When the increase and decrease pattern of each index acquired in step S6 is input to such a learned model, the pet's medical condition is output from the learned model, and the pet's medical condition can be thereby estimated. For example, a neural network can be used as an example of the learned model and, for example, deep learning can be used as an example of the learning algorithm in the learned model.

When the medical condition of the pet is estimated by using the learned model as described above, information other than the increase and decrease pattern of each index in the pet (for example, first management information, attribute information or the like) may be used as the learned model. In addition, the learned model may be generated (prepared) for each of the categories in which the above-mentioned pets are classified.

When the process of step S7 is executed, the transmission module 205 transmits (outputs) the provided information including the medical condition estimated in step S7 to the user terminal 30 used by the target user (step S8). The provided information transmitted to the user terminal 30 in step S8 may include, for example, the moving image received in step S1, the user ID, the pet ID, the second management information generated in step S4 (the second of the current day and the previous day), the increase and decrease pattern of each index acquired in step S6, and the like.

The provided information transmitted in step S8 is received by the user terminal 30 and displayed on (the display of) the user terminal 30 or the like. According to this, the user can recognize the medical condition of the pet (the medical condition from which the pet may suffer) and take appropriate measures such as bringing the pet to a hospital by confirming the provided information displayed on the user terminal 30.

In the present embodiment, it is assumed that the user has one pet (i.e., the pet toilet 100 and the pet have a one-to-one relationship), for convenience, and, when the user keeps a plurality of pets, for example, (the pet ID for identifying) the pet using the pet toilet 100 may be identified based on the moving image captured by the camera 12 provided in the sensor device 10 after the above-described process of step S1. An RF tag or the like attached to the pet may be used to identify the pet using the pet toilet 100.

In addition, it has been described that the processes following step S4 are executed in response to the instruction from the user, in FIG. 9, but, for example, when the processes of steps S1 and S2 are executed, the processes following step S4 may be automatically executed. In this case, the process of step S8 may be executed only when it is estimated that the pet has a specific medical condition (i.e., the pet may suffer from a disease) in step S7, and the process of step S8 may be omitted when the pet is healthy.

Furthermore, it has been described that the second management information of the current day and the previous day is generated in step S4 and the volatility of each index is calculated based on the second management information of the current day and the previous day in step S5 but, for example, the volatility of each index may be calculated based on the second management information of the current day and the second management information generated in advance when the pet is in a healthy state. Furthermore, for example, the volatility of each index may be calculated based on the second management information of the current day, the average value of the data (second management information) for last 7 days from the previous day, and the like.

In the present embodiment, as described above, a variation amount (first variation amount) in the amount of excreted urine and a variation amount (second variation amount) of the body weight in the pet are acquired, the medical condition of the pet is estimated based on the acquired variation amounts, and the provided information including the estimated medical condition is output (transmitted) to, for example, the user terminal 30. In the present embodiment, with such a configuration, it is possible to provide the user with information on the medical condition of the pet, and the user can recognize (detect) the medical condition of the pet at an early stage.

In the present embodiment, for example, the medical condition of the pet is estimated, based on the increase and decrease patterns of the amount of excreted urine and the body weight according to the variation amount of the amount of excreted urine and the variation amount of the body weight in the pet. Furthermore, in the present embodiment, the increase and decrease patterns of the amount of excreted urine and the body weight in the pet are acquired by using the statistical information on the amounts of excreted urine and the variation amounts (volatilities) of the body weights of a plurality of pets other than the pet. In the present embodiment, with such a configuration, since it is statistically evaluated that the amount of excreted urine and the body weight of the pet are increased or decreased so as to affect the estimation of the medical condition when estimating the medical condition of the pet, accuracy in the estimation of the medical condition can be improved. That is, in the present embodiment, it is possible to avoid determining that the amount of excreted urine and the body weight of the pet are increased or decreased and presuming an inappropriate medical condition although the variations (volatilities) in the amount of excreted urine and the body weight of the pet are within the range in which they can occur even in a case where the pet is statistically healthy.

In addition, in the present embodiment, the estimation accuracy of the medical condition can be further improved by acquiring the increase and decrease patterns with the statistical information on the variation amounts of the amounts of excreted urine and the body weights of a plurality of other pets common to the pet in at least one of age, gender, type and residence.

In the present embodiment, it has been described that the pet's medical condition estimated as described above is output as the provided information, but the provided information including the increase and decrease pattern of each index may be output instead of the medical condition. Even in such a case, the user can use the increase and decrease pattern of each index included in the provided information as information on the medical condition of the pet and can recognize (detect) the medical condition of the pet at an early stage.

Furthermore, in the present embodiment, the learned model generated by learning the variation amount of the amount of excreted urine and the variation amount of the body weight of each of a plurality of other pets, and learning the medical condition (correct answer data) actually occurring in each of the plurality of other pets may be used in estimating the medical condition of the pet. In the present embodiment, the provided information including the medical condition estimated by the information provision device 20 is provided to the user but, when the pet is diagnosed by a doctor based on the provided information, the user may be caused to input the diagnosis result (actual medical condition) via the user terminal 30. According to such a configuration, the above learned model can be learned by using the diagnosis result input by the user as correct answer data.

In addition, in the present embodiment, the amount of excreted urine and the body weight of the pet are measured using the pet toilet 100 in which the sensor device 10 is incorporated. According to this, the amount of excreted urine and the body weight of the pet can be monitored (acquired) without imposing a burden on the pet owner (user). The method of measuring the amount of excreted urine and the body weight of the pet described in the present embodiment is an example. That is, in the present embodiment, the method of measuring the amount of excreted urine and the body weight is not limited as long as the method estimates the medical condition of the pet based on the variation amount of the amount of excreted urine and the variation amount of the body weight of the pet.

In the present embodiment, it has been described that the amount of excreted urine, the body weight, the number of times of urination, the number of times of entry, the duration of stay, and the elapsed time are used as indexes for estimating the medical condition of the pet, but, for example, when the pet is a cat and the purpose is to detect the CKD at an early stage, as described above, the indexes may be at least the amount of excreted urine and the body weight. The other indexes may be appropriately selected according to, for example, the type of the pet, the medical condition to be estimated, and the like. In addition, the indexes for estimating the medical condition of the pet may be other than those described in the present embodiment.

In the present embodiment, it has been described that the amount of excreted urine and the body weight of the pet are measured using the pet toilet 100, but the amount of excreted feces of the pet can be measured using the pet toilet 100 (weight sensor 11).

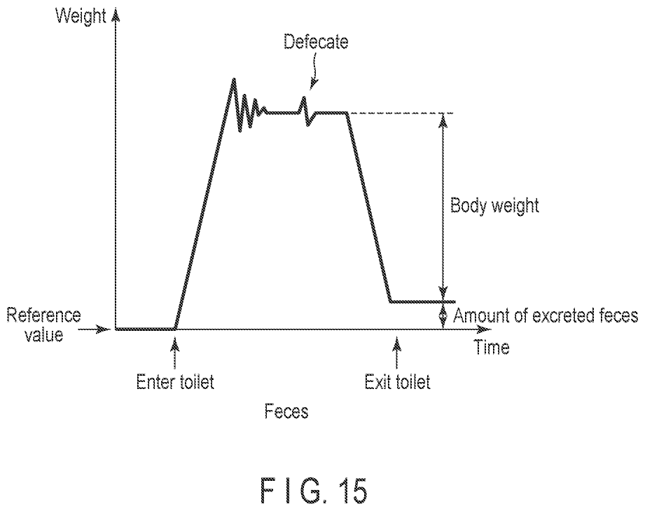

A principle of measuring the amount of excreted feces of the pet will be described below with reference to FIG. 15. FIG. 15 shows a transition of the weight measured by the weight sensor 11 when the pet defecates in the pet toilet 100.

For example, when a pet defecates in the pet toilet 100 described with reference to FIG. 3 and FIG. 4, feces excreted by the pet remain on the upper toilet container 101 unlike urine. For this reason, when the pet has not exited the pet toilet 100, the weight measured by the weight sensor 11 does not change before and after the defecation. However, when the pet exits the pet toilet 100, only the feces excreted by the pet remains on the upper toilet container 101, and (the difference between the reference value and) the weight measured by the weight sensor 11 at this time can be obtained as the amount of excreted feces. The weight of the pet in this case corresponds to a value obtained by subtracting the amount of excreted feces obtained as described above from the weight measured by the weight sensor 11 when the pet is in the pet toilet 100.

When the amount of excreted feces of the pet is thus measured, the amount of excreted feces can be used as one of the indexes for estimating the medical condition of the pet in the same manner as the above-mentioned amount of excreted urine. In other words, in the present embodiment, the medical condition of the pet may be estimated based on the variation amount of the amount of excrement including at least one of the amount of excreted urine and the amount of excreted feces of the pet.

In the present embodiment, the sensor device 10 incorporated in the pet toilet 100 includes the camera 12, and, for example, a moving image of the pet entering the pet toilet 100 is captured by the camera 12. In this case, the user can be provided with the provided information including the moving image thus captured by the camera 12. According to such a configuration, even when the user is at a position separated from a place where the pet toilet 100 is located (for example, a house or the like), the state of the pet can be confirmed by the moving image on the user terminal 30. That is, the information provision device 20 (information provision system) according to the present embodiment can also be used for watching over the pet. In the present embodiment, it has been described that the moving image is mainly captured by the camera 12, but the image captured by the camera 12 may be a still image. In this case, the user can be provided with the provided information including the still image.

Furthermore, in the present embodiment, it has been described that the user who is the owner of the pet is provided with the provided information but, for example, a doctor at a veterinary hospital and the like may be provided with the provided information (medical condition, moving image, second management information of the current day, second management information of the previous day, increase and decrease pattern of each index, and the like). According to such a configuration, the user can receive a doctor's diagnosis for the pet without taking the pet to the veterinary hospital, and the burden on the user can be reduced. That is, the information provision device 20 (information provision system) according to the present embodiment can also be used for online diagnosis of the pet.

In this embodiment, it is mainly assumed that the pet is a cat, but the pet may be the other animal (for example, a dog or the like) if the above-described amount of excreted urine, the body weight, and the like can be obtained.

Furthermore, in the present embodiment, for example, when a plurality of pets use the pet toilets 100 prepared for the respective pets, information on the plurality of pets (first management information, second management and the like) can be stored in the information provision device 20. The information (big data) thus accumulated in the information provision device 20 may be provided to, for example, a system other than the information provision system and used for processing in the other system.

Furthermore, in the present embodiment, it has been described that all of the modules 201 to 209 shown in FIG. 8 are included in the information provision device 20, but at least some of the modules 201 to 209 may be arranged in an external device (server device) different from the information provision device 20. More specifically, for example, the management module 202 and the management information storage 206 may be arranged in an external device, and the first management information may be acquired from the external device. In addition, the statistical information storage 208 may be arranged in an external device, and the statistical information may be acquired from the external device.

Moreover, it has been described that the information provision device 20 according to the present embodiment is a single device, but the device may be realized by cooperative operation of a plurality of devices.

### Second Embodiment

Next, a second embodiment of the present invention will be described. For example, a wide variety of products including pet food are supplied to pets, and the owner of the pet needs to select a suitable product from these products according to the condition of the pet. However, it is difficult for the owner to recognize all of these products, and a mechanism for assisting the owner (user) in selecting a product suitable for the pet is useful.

Therefore, the present embodiment is different from the above-mentioned first embodiment in providing provided information including information on a product suitable for the pet (hereinafter referred to as a recommended product).

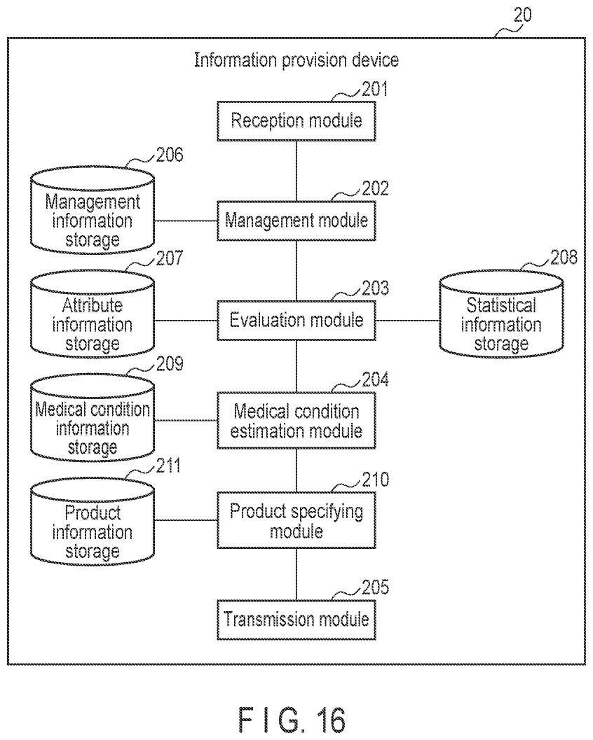

FIG. 16 is a block diagram showing an example of a functional configuration of an information provision device 20 according to the present embodiment. In the description of FIG. 16, the same reference numerals are denoted to the same portions as those of FIG. 8 described above, and detailed description thereof will be omitted. The portions different from those of FIG. 8 will be mainly described here.

Since a configuration of an information provision system, a configuration of a sensor device 10 (pet litter box 100), a hardware configuration of an information provision device 20, and the like are the same as those of the above-described first embodiment, the configurations will be appropriately described with reference to FIG. 2 to FIG. 4, FIG. 7 and the like.

In the present embodiment, the information provision device 20 further includes a product specifying module 210 and product information storage 211 in addition to the modules 201 to 209 described in the first embodiment described above.

In the present embodiment, it is assumed that, for example, the product specifying module 210 is implemented by executing an information provision program stored in the nonvolatile memory 22 by the CPU 23 (that is, the computer of the information provision device 20) shown in FIG. 7, that is, by software. For example, the product specifying module 210 may be realized by hardware or may be realized as a combination of software and hardware.

In addition, the product information storage 211 is realized by, for example, the nonvolatile memory 22 shown in FIG. 7, the other storage device or the like.

The product specifying module 210 specifies the recommended product (i.e., product suitable for the pet), based on the product information stored in the product information storage 211. The recommended product specified by the product specifying module 210 includes, for example, (a type of) pet food supplied to the pet. The details of the processing of the product specifying module 210 and the product information stored in the product information storage 211 will be described later.

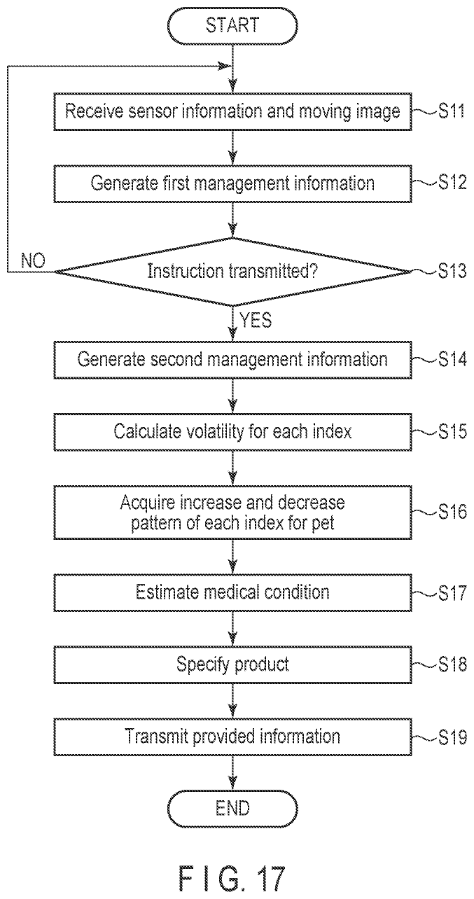

Next, an example of the processing procedure of the information provision device 20 according to the present embodiment will be described with reference to a flowchart of FIG. 17.

First, processes of steps Sll to S17 corresponding to the above-described processes of steps S1 to S7 shown in FIG. 9 are executed. When it is determined in step S13 that there is no instruction from the user, the flow returns to step Sll and the processes are repeated.

When the process of step S17 is executed, the product specifying module 210 specifies the recommended product based on the product information stored in the product information storage 211 as described above (step S18).

The product information in the present embodiment will be described. The product information is information indicating the product (recommended object) such as a product name, and the product information is tagged with, for example, the increase and decrease pattern of each index described in the first embodiment described above. In the present embodiment, “tagging” means setting conditions for specifying the product indicated by the product information as the recommended product.

More specifically, for example, the product information indicating (a product) of kidney care food is tagged with the increase and decrease pattern of each index such that the CKD is estimated by the medical condition estimation module 204. In the present embodiment, the product information thus tagged is prepared for each product and stored in a form of database.

In step S18, the product information tagged with an increase and decrease pattern that matches the increase and decrease pattern of each index in the pet acquired in step S16 is retrieved in the product information thus stored in the form of database, such that the product indicated by the retrieved product information can be specified as the recommended product.

Retrieving the product information tagged with the increase and decrease pattern that matches the increase and decrease pattern of each index in the pet acquired in step S16 has been described, but product information tagged with an increase and decrease pattern similar to the increase and decrease pattern of each index in the pet may be retrieved in step S18. In this case, for example, the increase and decrease pattern of each index in the pet is compared with the increase and decrease pattern of each index with which the product information is tagged, and the degree of similarity (i.e., matching degree) based on the degree of matching of the increase and decrease (i.e., evaluation result for the volatility) for each index is calculated. When the increase and decrease matches in all the indexes, 100% are calculated as the degree of similarity. When the similarity thus calculated is higher than or equal to a predetermined value (i.e., a threshold value), it is determined that the increase and decrease pattern of each index in the pet and the tagged increase and decrease pattern of each index are similar to each other. When calculating the similarity, each index is weighted and, for example, when the increase and decrease of a specific index is the same, a high degree of similarity may be calculated even if the increase and decrease of the other indexes is different.

The number of recommended products specified in step S18 may be plural. In addition, in the process of step S18, the recommended product may be specified by further considering information such as the ranking of products for a plurality of other pets belonging to the category in which the pets are classified as described above (for example, a product of a higher ranking may be preferentially identified as the recommended product).

It has been described that the product information is tagged with the increase and decrease pattern of each index, but the product information may be tagged with the other information.

More specifically, the product information may be tagged with, for example, a range of at least one of the amount of excreted urine, the body weight, the number of times of urination, the number of times of entry, the duration of stay, the elapsed time and the like. For example, when the product information is tagged with the range of the body weight and when the body weight of the pet falls within the tagged range of the body weight, the product indicated by the product information can be specified as the recommended product. The body weight of the pet can be obtained from the second management information (second management information of the current day) generated in step S14.

In addition, the product information may be tagged with attribute information (age, gender, type and region). In this case, the product indicated by the product information tagged with the attribute information that matches or is similar to the attribute information on the pet can be specified as the recommended product.

Furthermore, in step S18, for example, a learned model generated to output the recommended product by inputting the above-described increase and decrease pattern of each index in the pet, the second management information (amount of excreted urine, body weight, number of times of urination, number of times of entry, duration of stay and elapsed time) generated in step S14, attribute information (age, gender, type and region) on the pet, and the like may be used.

When the process of step S18 is executed, the transmission module 205 transmits (outputs) to the user terminal 30 the provided information including the medical condition estimated in step S17 and (the product name, and the like of) the recommended product specified in step S18 (step S19). The provided information transmitted to the user terminal 30 in step S19 may include other information, similarly to the above-described first embodiment.

The provided information transmitted in step S19 is received by the user terminal 30 and displayed on (the display of) the user terminal 30 or the like. According to this, the user can recognize the medical condition of the pet and (the product name of) the product suitable for the pet by confirming the provided information displayed on the user terminal 30.

As described above, in the present embodiment, the product (recommended product) suitable for the pet is specified based on the variation amount (first variation amount) of the amount of excreted urine and the variation amount (second variation amount) of the body weight of the pet, and the provided information including the product is output (transmitted) to, for example, the user terminal 30. In the present embodiment, such a configuration enables the user to easily select the product suitable for the pet from a wide variety of products, based on the provided information (i.e., the information on the product).

In the present embodiment, it has been described that the recommended product is specified based on the increase and decrease patterns (variation amounts) of all the indexes of the amount of excreted urine, the body weight, the number of times of urination, the number of times of entry, the duration of stay and the elapsed time, but the recommended product may be specified based on, for example, at least the amount of excreted urine and the body weight, and the other indexes may also be appropriately selected.

The information provision system (information provision device 20) according to the present embodiment may include a function of executing a payment process for purchasing the recommended product. For example, this payment process may be executed in response to a user's operation on the user terminal 30 or may be automatically executed when the provided information is transmitted to the user terminal 30. In this case, the information provision system may be configured to operate in cooperation with the other system in order to realize the purchase of the recommended product.

In addition, in the present embodiment, it is assumed that the recommended product is (the type of) pet food and, for example, an optimum feeding amount is often set for the pet food, based on the age and the body weight of the pet. In this case, the above-mentioned product information can be tagged with the optimum feeding amount per age and 1 kg of body weight. According to this, for example, when the recommended product (i.e., the type of pet food) is specified, the optimum feeding amount of the recommended product can be calculated according to the age and the body weight of the pet, and the user can be provided with the optimum feeding amount as the information on the recommended product.

In the present embodiment, the case where the recommended product is the pet food as described as described above, has been described, but the recommended product may be the other product. More specifically, the recommended product may be a drug an insurance product, and the like suitable for the pet. In addition, in the present embodiment, for example, by storing information indicating hospitals tagged in the same manner as the above-mentioned product information, in the form of database, the present embodiment can be applied to a case of providing the user with the information on a hospital suitable for (the medical condition of) the pet (i.e., introducing a hospital). That is, in the present embodiment, information useful for the pet such as the above-mentioned information indicating the hospital may be specified, and the user may be provided with information useful for the pet. The information useful for the pet may include, for example, advertisements, articles and the like.

The method described in the above-described embodiment can be stored in a storage medium such as a magnetic disk (hard disk or the like), an optical disk (CD-ROM, DVD or the like), a magneto-optical disk (MO), or a semiconductor memory as a program that can be executed by a computer, and can be distributed.

In addition, any form of the storage format in the storage medium may be used as long as the storage medium is capable of storing a program and being readable by a computer.

Furthermore, an operating system (OS), middleware (MW) such as database management software and network software, and the like running on the computer based on instructions of a program installed from a storage medium into the computer, may execute a part of each process to realize the present embodiment.

Furthermore, the storage medium in the present invention is not limited to a medium independent of the computer, but also implies a storage medium in which a program transmitted by a LAN, the Internet, or the like is downloaded and stored or temporarily stored.

In addition, the storage medium is not limited to one storage medium and, when the processes in the present embodiment are executed by a plurality of media, the media are implied in the storage medium in the present invention, and the medium configuration may be any configuration.

The computer in the present invention executes each process in the present embodiment, based on the programs stored in the storage medium, and any configuration of one device such as a personal computer or a system in which a plurality of devices are connected to the network may be used.

In addition, the computer in the present invention is not limited to a personal computer, but also implies an arithmetic processing unit, a microcomputer, and the like included in an information processing device, and generically refers to a device or an apparatus capable of realizing the functions of the present invention by programs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information provision device comprising:
a processor configured to:
acquire a first variation amount of an amount of excrement and a second variation amount of a body weight in a pet;
estimate a medical condition of the pet, based on the acquired first variation amount and the acquired second variation amount; and
output provided information including the estimated medical condition.

2. The information provision device of claim 1, wherein
the processor is configured to estimate the medical condition of the pet, based on increase and decrease patterns of the amount of excrement and the body weight in the pet corresponding to the acquired first variation amount and the acquired second variation amount.

3. The information provision device of claim 2, wherein
the increase and decrease patterns of the amount of excrement and the body weight in the pet are acquired by using statistical information on variation amounts of the amount of excrement and the body weight in a plurality of pets other than the pet.

4. The information provision device of claim 3, wherein
the plurality of other pets are common to the pet in at least one of age, gender, type, residence, and experience or no experience of undergoing contraception or castration.

5. The information provision device of claim 1, wherein
the processor is configured to estimate the medical condition of the pet by inputting the acquired first variation amount and the acquired second variation amount to a leaned model generated by learning the variation amount of the amount of excrement and the variation amount of the body weight in each of the plurality of pets other than the pet and learning the medical condition occurring in each of the plurality of pets.

6. The information provision device of claim 1, communicably connected to a sensor device incorporated into a pet toilet used by the pet and configured to measure the first variation amount of the amount of excrement and the second variation amount of the body weight in the pet, wherein
the processor is configured to acquire the first variation amount of the amount of excrement and the second variation amount of the body weight in the pet, from the sensor device.

7. The information provision device of claim 6, wherein
the sensor device includes a camera,
the processor is configured to:
acquire an image including the pet captured by the camera while the pet uses the pet toilet; and
output provided information including the acquired image.

8. The information provision device of claim 1, wherein
the processor is configured to:
specify a product suitable for the pet or information useful for the pet, based on the acquired first variation amount and the acquired second variation amount; and
output provided information including the specified product or the specified information.

9. The information provision device of claim 8, wherein
the product suitable for the pet includes pet food or insurance product.

10. An information provision device comprising:
a processor configured to:
acquire a first variation amount of an amount of excrement and a second variation amount of a body weight in a pet;
acquire increase and decrease patterns of the amount of excrement and the body weight in the pet corresponding to the acquired first variation amount and the acquired second variation amount; and
output provided information including the acquired increase and decrease patterns, wherein
the increase and decrease patterns are acquired by using statistical information on variation amounts of the amount of excrement and the body weight in a plurality of pets other than the pet.

11. An information provision method executed by an information provision device, the method comprising:
acquiring a first variation amount of an amount of excrement and a second variation amount of a body weight in a pet;
estimating a medical condition of the pet, based on the acquired first variation amount and the acquired second variation amount; and
outputting provided information including the estimated medical condition.

12. A non-transitory computer-readable storage medium having stored thereon a computer program which is executable by a computer of an information provision device, the computer program comprising instructions capable of causing the computer to execute functions of:
acquiring a first variation amount of an amount of excrement and a second variation amount of a body weight in a pet;
estimating a medical condition of the pet, based on the acquired first variation amount and the acquired second variation amount; and
outputting provided information including the estimated medical condition.
